(19) United States
(12) Patent Application Publication
(10) Pub. No.: US 2008/0231229 A1
(43) Pub. Date: Sep. 25, 2008

(54) Charging Device

(76) Inventors: Takao Aradachi, Hitachinaka-shi (JP); Shinji Watanabe, Hitachinaka-shi (JP); Haruhisa Fujisawa, Hitachinaka-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/050,236

(22) Filed: Mar. 18, 2008

(30) Foreign Application Priority Data
Mar. 19, 2007 (JP) P2007-71645

(51) Int. Cl. H02J 7/00

(52) U.S. Cl. 320/107

(57) ABSTRACT

A charging device includes a charging unit, a detecting unit, a determining unit, a current generating unit, an adjusting unit, and a display unit. The charging unit charges a battery. The detecting unit detects a voltage developed across the battery. The determining unit determines a charging state of the battery based on the voltage. The current generating unit generates a current. The adjusting unit adjusts the current based on the charging state. The display unit emits a first light having a first color and a first intensity in response to the current supplied thereto. The first intensity changes in accordance with changing of the current.

### BACKGROUND OF THE INVENTION

1. Field of the Invention

The present invention relates to a charging device for charging a secondary battery such as a lithium ion secondary battery.

2. Description of Related Art

In general, a portable device uses a secondary battery that is chargeable with a charging device as a power supply. Japanese Patent Application Publication No. 10-174308 provides a charging device that displays a charged amount (remaining capacity) of the secondary battery with a plurality of LEDs each emitting a signal having a color corresponding to a charging state.

### SUMMARY OF THE INVENTION

However, since a worker who uses an electric tool often works at a place that is distant from the charging device, the distant worker cannot distinguish the signal emitted from the LED. Thus, the distant worker cannot distinguish the charging state, such as, a charging completed state.

In view of the above-described drawbacks, it is an objective of the present invention to provide a charging device capable of informing a user who is distant from the charging device to some extent of the charging state clearly.

In order to attain the above and other objects, the present invention provides a charging device including a charging unit, a detecting unit, a determining unit, a current generating unit, an adjusting unit, and a display unit. The charging unit charges a battery. The detecting unit detects a voltage developed across the battery. The determining unit determines a charging state of the battery based on the voltage. The current generating unit generates a current. The adjusting unit adjusts the current based on the charging state. The display unit emits a first light having a first color and a first intensity in response to the current supplied thereto. The first intensity changes in accordance with changing of the current.

### BRIEF DESCRIPTION OF THE DRAWINGS

The above and other objects, features and advantages of the invention will become more apparent from reading the following description of the preferred embodiments taken in connection with the accompanying drawings in which:

FIG. 1 shows a circuit diagram of a charging device of a preferred embodiment of the present invention; and

FIG. 2 shows a flowchart illustrating a control of displaying charging states according to the charging device of the preferred embodiment.

### DETAILED DESCRIPTION OF THE PREFERRED EMBODIMENTS

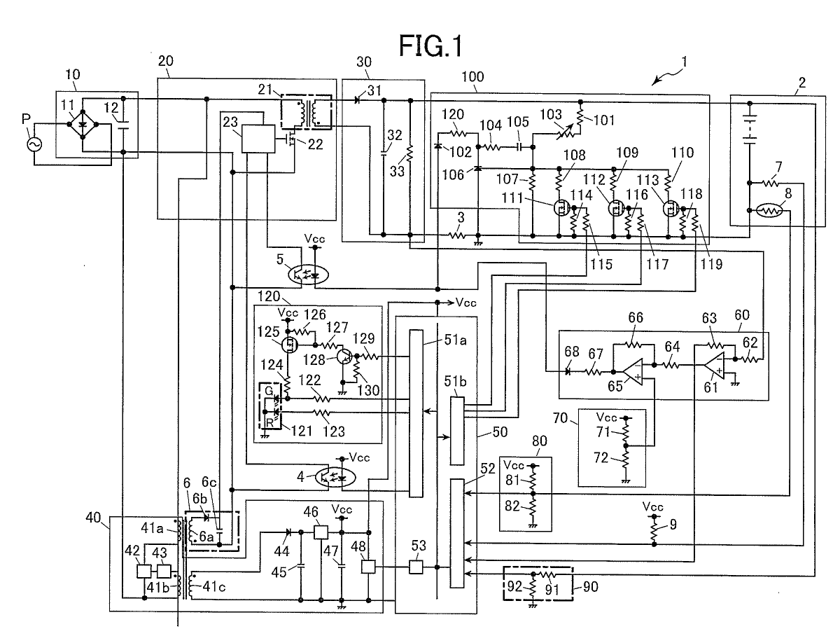

FIG. 1 shows the circuit diagram of the charging device 1 according to the preferred embodiment of the present invention. The charging device 1 charges a battery pack 2 with power supplied from an alternating-current power supply P.

The battery pack 2 includes a plurality of battery cells connected in series, a first battery type determination resistor 7 and a thermosensor 8. The thermosensor 8 is a thermistor and provided close to the battery pack 2.

The charging device 1 is provided with a current detection unit 3, a charging control signal transmission unit 4, a charging current signal transmission unit 5, a rectification smoothing circuit 6, a second battery type determination resistor 9, a rectification smoothing circuit 10, a switching circuit 20, a rectification smoothing circuit 30, a power supply 40, a microcomputer 50, a charging current control circuit 60, a charging current setting unit 70, a battery temperature detection unit 80, a battery voltage detection unit 90, a charging voltage control unit 100, and a display unit 120.

The rectification smoothing circuit 10 includes a full-wave rectifier circuit 11 and a smoothing capacitor 12. The full-wave rectifier circuit 11 rectifies the alternating-current supplied from the alternating-current power supply P, and the smoothing capacitor 12 smoothes the direct-current outputted from the full-wave rectifier circuit 11.

The switching circuit 20 includes a high-frequency transformer 21, a MOSFET 22, and the PWM control IC 23. The PWM control IC 23 changes the drive pulse width applied to the MOSFET 22 in order to adjust a voltage outputted to the rectification smoothing circuit 30.

The rectification smoothing circuit 30 includes a diode 31, a smoothing capacitor 32, and a discharging resistor 33. The diode 31 rectifies the alternating-current supplied from the switching circuit 20, and the smoothing capacitor 32 smoothes the direct-current outputted from the diode 31.

The second battery type determination resistor 9 divides a reference voltage Vcc together with the first battery determination resistor 7. The divided voltage is outputted as cell number information indicative number of the cells included in the battery pack 2. The charging current setting unit 70 includes resistors 71 and 72. The reference voltage Vcc is divided by the resistors 71 and 72, and the divided voltage is outputted as a reference value for setting the charging current. The battery temperature detection unit 80 includes resistors 81 and 82. The reference voltage Vcc is divided by the thermosensor 8 and the resistors 81 and 82, and the divided voltage is outputted as battery temperature information. The battery voltage detection unit 90 includes resistors 91 and 92. The battery voltage is divided by the resistors 91 and 92, and the divided voltage is outputted as battery voltage information.

The current detection unit 3 is a resistor, and detects a voltage applied to the resistor in order to obtain a charging current flowing through the battery pack 2. The charging current control circuit 60 includes operational amplifiers 61 and 65, resistors 62, 63, 64, 66 and 67, and a diode 68, and outputs a current control signal based on both the charging current (the voltage) detected by the current detection unit 3 and the reference value outputted from the charging current setting unit 70.

The charging current signal transmission unit 5 is a photocoupler, and transmits the current control signal outputted from the charging current control circuit 69 to the PWM control IC 23.

The microcomputer 50 includes output ports 51a and 51b, an A/D input port 52, and a reset port 53. The cell number information outputted from the second battery type determination resistor 9, the battery temperature information outputted from the battery temperature detection unit 80, the battery voltage information outputted from the battery voltage detection unit 90, and the voltage detected by the current detection unit 3 are inputted into the A/D port 52.

The microcomputer 50 outputs a start signal, a stop signal, and a charging state signal from the output port 51a. The charging state signal is the reference voltage Vcc. Further, the microcomputer 50 determinates the number of the cells included in the battery pack 2 based on the cell number information, and outputs a charging voltage control signal corresponding to the number of the cells from the output port 51b. Note that the microcomputer 50 may determine a battery type based on the cell number information.

The charging device 1 (the microcomputer 50) charges the battery back 2 at a constant current until the charging current reaches a predetermined current, and at a constant voltage after the charging current has reached the predetermined current.

The charging voltage control unit 100 includes resistors 101, 104, 107, 108, 109, 110, 114, 115, 116, 117, 118, 119 and 120, a potentiometer 103, FETs 111, 112 and 113, a capacitor 105, a shunt regulator 106, and a rectifier diode 102.

The shunt regulator 106 has a reference terminal, and controls a charging voltage based on a voltage inputted into the reference terminal. The resistors 107, 108, 109 and 110 are connected to the reference terminal of the shunt regulator 106 in parallel. The FETs 111, 112 and 113 are connected to the resistors 107, 108, 109 and 110 respectively. The charging voltage control signal outputted from the output port 51b is inputted into gate terminals of the FETs 111, 112 and 113, causing the FETs 111, 112 and 113 to turn on.

When the microcomputer 50 determines that the battery pack 2 has two cells, the microcomputer 50 does not output the charging voltage control signal from the output port 51b to any of the gate terminals of the FETs 111, 112 and 113. Thus, a voltage divided by a series resistance of the resistor 101 and the potentiometer 103, and the resistor 107 is inputted into the reference terminal to set a charging voltage corresponding to the two cells.

When the microcomputer 50 determines that the battery pack 2 has three cells, the microcomputer 50 outputs the charging voltage control signal from the output port 51b to the gate terminal of the FET 111. Thus, a voltage divided by the series resistance of the resistor 101 and the potentiometer 103, and a parallel resistance of the resistor 107 and the resistor 108 is inputted into the reference terminal to set a charging voltage corresponding to the three cells.

When the microcomputer 50 determines that the battery pack 2 has four cells, the microcomputer 50 outputs the charging voltage control signal from the output port 51b to the gate terminal of the FET 112. Thus, a voltage divided by the series resistance of the resistor 101 and the potentiometer 103, and a parallel resistance of the resistor 107 and the resistor 109 is inputted into the reference terminal to set a charging voltage corresponding to the four cells.

When the microcomputer 50 determines that the battery pack 2 has five cells, the microcomputer 50 outputs the charging voltage control signal from the output port 51b to the gate terminal of the FET 113. Thus, a voltage divided by the series resistance of the resistor 101 and the potentiometer 103, and a parallel resistance of the resistor 107 and the resistor 110 is inputted into the reference terminal to set a charging voltage corresponding to the five cells.

The charging control signal transmission unit 4 is a photocoupler, and transmits the start signal and the stop signal outputted from the output port 51a to the PWM control IC 23.

The power supply 40 includes transformers 41a to 41c, a switching element 42, a control element 43, a rectifier diode 44, capacitors 45 and 47, a regulator 46, and a reset IC 48, and supplies power to the microcomputer 50 and the rectification smoothing circuit 6. The rectification smoothing circuit 6 includes a transformer 6a, a rectifier diode 6b, and a smoothing capacitor 6c, and supplies the power supplied from the power supply 40 to the PWM control IC 23.

The display unit 120 includes an LED 121, resistors 122, 123, 124, 126, 127, 129 and 130, an FET 125 of Pch, and a transistor 128. The LED 121 includes a green diode G and a red diode R. When the charging state signal outputted from the output port 51a is inputted into the green diode G via the resistor 122, the green diode G lights up with green color. When the charging state signal is inputted into the red diode R via the resistor 123, the red diode R lights up with red color.

The green diode is also connected to the reference voltage Vcc via the resistor 124 and the FET 125. A gate of the FET 125 is connected to the output port 51a via the transistor 128. When the charging state signal is inputted into the transistor 128, the transistor 128 turns ON. When the transistor 128 turns ON, the FET 125 also turns ON. When the FET 125 turns ON, the reference voltage Vcc is applied to the green diode G via the resistor 124, causing the green diode G to light up with the green color.

Further, a resistance value of the resistor 124 is smaller than that of the resistor 122. Thus, the green diode G lights up more strongly (blightly) when the current is flowed via the resistor 124 than when the current is flowed via the resistor 122.

Furthermore, when the charging state signal are inputted into both the green diode G via the resistor 122 and the red diode R via the resistor 123 concurrently, the LED 121 lights up with orange color. If a current is flowed through the LED 121 via the resistor 124, green color surpasses red color. Accordingly, with respect to green color, a current is flowed via the resistor 122.

In the preferred embodiment, the LED 121 lights up with the red color before charging, with the orange color during charging, and with the green color after charging.

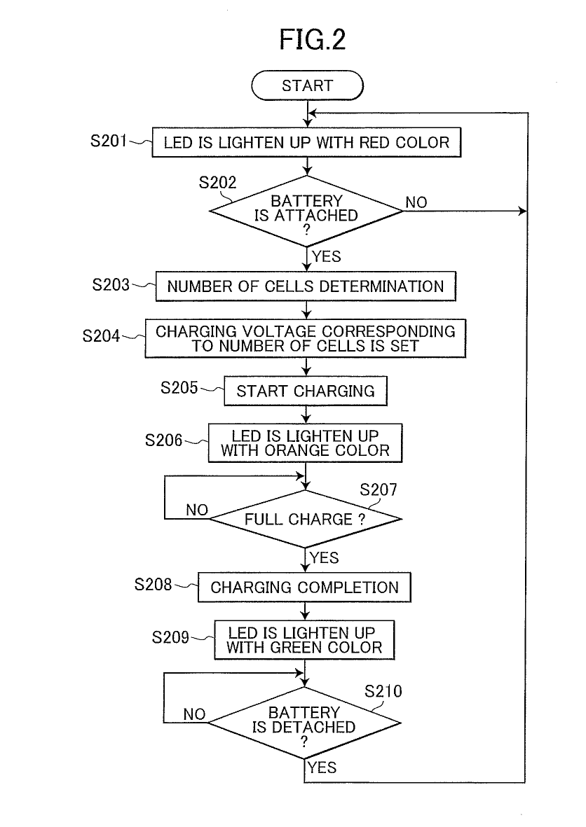

FIG. 2 shows a flowchart illustrating a control of displaying the charging states.

Before the battery pack 2 is attached to the charging device 1, the microcomputer 50 outputs a high signal (the reference voltage Vcc) as the charging state signal from the output port 51a to the LED 121 via the resistor 123 so that the LED 121 lights up with the red color (step 201).

Next, the microcomputer 50 determines whether or not the battery pack 2 is attached to the charging device 1 in response to the input from the battery temperature detection unit 80, battery type determination unit 9, and battery voltage detection unit 90 (step 202). If the battery pack 2 is attached (step 202: YES), the microcomputer 50 determines the number of cells based on the cell number information inputted by the battery type determination unit 9 (step 203), and sets a charging voltage corresponding to the number of the cells determined in step 203 (step 204).

Next, the microcomputer 50 outputs a low signal as the start signal from the output port 51a to the photocoupler 4 to set the PWM control IC 23 in an operation state (step 205). In this way, the charging is started. In the start of the charging, as is generally known, the microcomputer 50 charges the battery pack 2 at a constant current. The microcomputer 50 outputs high signals (the reference voltage Vcc) as the charging state signal from the output port 51a to the LED 121 via both the resistors 122 and 123 during charging so that the LED 121 lights up with the orange color (step 206).

After the charging is started, the microcomputer 50 monitor the charging current based on the voltage inputted from the current detection unit 3 into the A/D port 52. As the charging goes, the battery voltage increases gradually. When the battery voltage has reached a predetermined value, the microcomputer 50 changes the charging method from the constant current charging to the constant voltage charging. When the battery pack 2 is charged at the constant voltage, the charging current reduces gradually.

The microcomputer 50 determines whether the charging current (the voltage) has reached a predetermined current (s207). If the charging current has reached the predetermined current (S207: YES), the microcomputer 50 determines that the battery 2 is fully charged and outputs a high signal as the stop signal from the output port 51a to the photocoupler 4 to set the PWM control IC 23 in the stop state (step 208).

After stopping the charging, the microcomputer 50 outputs a high signal as the charging state signal from the output port 51a to the transistor 128 to turn on. By turning on the transistor 128, the FET 125 also turns on, and the reference voltage Vcc is applied to the LED 121 via the resistor 124, causing the LED 121 to light up with the green color strongly (brightly) (step 209).

Then, the microcomputer 50 determines whether the battery pack 2 is detached from the charging device 1 (S210). If the battery pack 2 is detached from the charging device 1 (step 210: YES), the processing returns to step 201.

As described above, when the charging is completed, a high voltage is applied to the LED 121 via the resistor 124. Thus, the user who is distant from the charging device 1 can clearly understand that the charging has been completed. Furthermore, during the charging, the current is flowed through the LED 121 via the resistor 122. The value of the current which is flowed thorough the LED 121 via the resister 123 is smaller than the value of the current which is flowed through the LED 121 via the resistor 124. Thus, energy is saved. Furthermore, during the charging, the current is flowed via the resistor 122. Thus, the orange color can be correctly displayed, since the green color is not too strong.

Further, in the preferred embodiment, when it is required to flow a strong current to the LED 121, the reference voltage Vcc is applied to the LED 121 via the resistor 124. Thus, the strong current is prevented from flowing in the digital circuit such as the microcomputer 50.

While the invention has been described in detail with reference to the specific embodiment thereof, it would be apparent to those skilled in the art that various changes and modifications may be made therein without departing from the spirit of the invention.

What is claimed is:

1. A charging device comprising:
a charging unit configured to charge a battery;
a detecting unit configured to detect a voltage developed across the battery;
a determining unit configured to determine a charging state of the battery based on the voltage;
a current generating unit configured to generate a current;
an adjusting unit configured to adjust the current based on the charging state; and
a display unit configured to emit a first light having a first color and a first intensity in response to the current supplied thereto, the first intensity changing in accordance with changing of the current.

2. The charging device according to claim 1, wherein the display unit is an LED.

3. The charging device according to claim 1, wherein the current generating unit comprises:
a first current generating unit configured to generate a first current; and
a second current generating unit configured to generate a second current smaller than the first current,
wherein the adjusting unit selects, based on the charging state, one of the first current generating unit and the second current generating unit to supply the current to the display unit.

4. The charging device according to claim 3, wherein the first current generating unit comprises:
a first voltage generating unit configured to generate a predetermined voltage; and
a first resistor having a first resistance value and connected between the first voltage generating unit and the display unit,
wherein the second current generating unit comprises:
a second voltage generating unit configured to generate the predetermined voltage; and
a second resistor having a second resistance value smaller than the first resistance and connected between the second current generating unit and the display unit.

5. The charging device according to claim 4, wherein the first voltage generating unit is a digital power source, and the second voltage generating unit is an analog power source.

6. The charging device according to claim 3, wherein the charging state includes a full charging state indicating a state in which the battery has been fully charged,
wherein the adjusting unit selects the second current generating unit in response to the full charging state to supply the second current to the display unit.

7. The charging device according to claim 3, wherein the display unit further emits a second light having a second color and a second intensity in response to the current supplied thereto,
wherein the adjusting unit selects the first current generating unit to supply the first current to the display unit when the display unit emits both the first light and the second light simultaneously.
